(19) United States
(12) Patent Application Publication
(10) Pub. No.: US 2023/0293383 A1
(43) Pub. Date: Sep. 21, 2023

(54) Massage Device With Optimized Automatic Operating Mode

(71) Applicant: SEB S.A., Ecully (FR)

(72) Inventors: Yohan Dassonville, Dardilly (FR); Vivien Marzin, Verze (FR); Ambroise De La Chapelle, Saint-Genis-Les-Ollieres (FR)

(73) Assignee: SEB S.A., Ecully (FR)

(21) Appl. No.: 18/021,276

(22) PCT Filed: Aug. 10, 2021
(86) PCT No.: PCT/EP2021/072315

§ 371 Date: Feb. 14, 2023

(30) Foreign Application Priority Data
Aug. 14, 2020 (FR) FR2008498

(51) Int. Cl. A61H 15/00

(52) U.S. Cl. CPC A61H 15/0085; A61H 2201/5007; A61H 2201/5035; A61H 2201/1207; A61H 2205/022; A61H 2201/1671

(57) ABSTRACT

A massage device includes
a first selection interface configured to allow a user to select an automatic or manual operating mode of the device, the automatic operating mode providing a treatment cycle for the area to be massage;
a second selection interface configured to allow a user to select a parameter related to the automatic operation mode of the device and representative of a massage setting;
a massage head including at least one massage element configured to come into contact with the area to be massaged; and
an actuator enabling activation of said at least one massage element. The device further includes
a controller configured to automatically select a first mode or a second mode of operation of the automatic operation of the device, depending on the user-selected setting, wherein the first mode and the second mode are each associated with a particular operation of the actuator.

### TECHNICAL FIELD

The present invention relates to the general technical field of massage or skin care devices, more particularly for household use and preferentially for mechanically massaging the skin, in particular the face.

Advantageously, the invention relates to a massage device comprising:
a first selection interface allowing a user to select an automatic or manual operating mode of the device, said automatic operating mode providing a treatment cycle for the area to be massaged,
a second selection interface allowing a user to select a setting related to the automatic operating mode of the device and representative of a massage setting,
a massage head comprising at least one massage element intended to come into contact with the area to be massaged,
an actuator enabling activation of said at least one massage element characterized in that the device further comprises
a controller automatically selecting a first operating mode or a second operating mode of the automatic operation of the device, based on said user-selected setting, said first mode and second mode each associated with a particular operation of the actuator.

### PRIOR ART

Massage, especially human facial massage, has long been reserved for people who can call on a professional in the field. Indeed, massage requires certain specific techniques, gestures and methods mastered by only a few professionals: masseurs.

To try to make massage accessible to as many people as possible, different massage devices have been proposed in order to provide consumers with a device that reproduces some of the gestures of professional masseurs. However, even with a device that reproduces certain massage techniques, the result of the massage is not guaranteed. Indeed, the result and effectiveness of the massage not only depend on the technical gestures, but also on the method by which the technical gestures are applied to the area to be massaged. However, this method is often unknown to consumers of this type of device, and it is very difficult for them to know how to use a massage device correctly.

In order to address this massage method problem, some of these devices include an automatic mode, that is, a mode that allows the user to not worry about the massage method and to simply follow the routine pre-recorded in the device.

One example is U.S. Pat. No. 9,730,758. It tells the user, using a graphic display, to which area of the face to apply the device as the automatic massage program progresses.

This solution, although generally satisfactory, does not allow the user any freedom. Thus, the user's habits and preferences are not taken into account: the user is forced to strictly adhere to the massage sequence imposed by the device.

There is thus a need to improve the existing devices.

### SUMMARY OF THE INVENTION

The present invention aims to remedy the aforementioned drawbacks.

One purpose of the invention is to provide a massage device that makes it possible to meet the user's personal preferences and habits, even when using an automatic massage program, while guaranteeing an optimal result, regardless of the user's preferences or habits.

Another purpose of the invention is to propose a massage device that is particularly simple, intuitive and ergonomic to use, for any user, in particular a consumer.

Another purpose of the invention is to propose a massage device that is particularly safe and secure for any user, in particular a consumer.

Another purpose of the invention is to propose a massage device that is particularly inexpensive to manufacture.

Another purpose of the invention is to propose a massage device that is particularly reliable and robust.

Another purpose of the invention is to propose a massage device that is particularly energy-efficient.

Another purpose of the invention is to propose a preferentially non-therapeutic massage method that can take into account a user's preferences or habits, even as part of an automatic massage program, while guaranteeing an optimal result, regardless of the user's preferences or habits.

Another purpose of the invention is to propose a preferentially non-therapeutic massage method that is particularly simple, intuitive and understandable, for any user, in particular a consumer.

These purposes are achieved using a massage device comprising:
a first selection interface allowing a user to select an automatic or manual operating mode of the device, said automatic operating mode providing a treatment cycle for the area to be massaged,
a second selection interface allowing the user to select a setting related to the automatic operating mode of the device and representative of a massage setting,
a massage head comprising at least one massage element intended to come into contact with the area to be massaged,
an actuator enabling activation of said at least one massage element,
a controller automatically selecting a first operating mode or a second operating mode of the automatic operation of the device, based on said user-selected setting, said first mode and second mode each associated with a particular operation of the actuator.

With the invention and said setting, the user of the massage device can indicate a preference related to the massage. The massage device will then take this preference into account and automatically adjust the automatic operating mode of the device accordingly. In other words, the user sees his or her habits and preferences taken into account by the automatic mode of the massage device. The result is greater user satisfaction, user appreciation and improved acceptance of the massage device since it adjusts to the user's preferences. In addition, by automatically adjusting the automatic operating mode of the massage device to the setting indicated by the user, the massage device that is the subject-matter of the invention guarantees an optimal result, regardless of the setting indicated by the user, and therefore regardless of the user's habits or preferences. This also limits the risk of inadvertent misuse of the device by the user, as the user's habits and reflexes are taken into account.

“User” is preferentially defined as a human being, regardless of gender, who will benefit from the massage provided by the device. Advantageously, the device that is the subject-matter of the invention is designed to be used on oneself, that is, the user will hold the massage device in his or her hand and apply it directly to his or her own body, and in particular to his or her face. This use is generally a “consumer” use, meaning by a user who has no particular knowledge of massage. However, it could be conceived, without departing from the scope of the invention, that the invention is used by one person on another person. In this case, the term “user” could then refer to the person handling the device rather than the person receiving the massage.

“Massage device” means any device capable of providing mechanical action on a user's area to be massaged, particularly the skin. More preferentially, the massage device according to the invention is a facial massage device, advantageously of the human face. The massage device according to the invention can reproduce different massage gestures, usually performed by the fingers of professionals in the sector. Thus, illustratively and without limitation, the massage device may reproduce either of the following gestures:
Kneading or shearing, particularly well-suited to treating the cheekbones, cheeks, oval of the face (the area between the jaws, the chin), or neck.
Tapping, especially well-suited to treating the eye area or even the forehead.
Palpate-roll, particularly well-suited to treating the cheeks, neck,
Jacquet pinch, particularly well-suited to treating the cheeks, neck, forehead, eye area or mouth area.
   These various gestures are well known to the person skilled in the art and advantageously make it possible to provide aesthetic benefits to the skin, especially to the skin of the face. More specifically, the upper layers of the skin are essentially solicited and impacted by these gestures, such that only an aesthetic effect is advantageously achieved, and not a therapeutic effect.

Preferentially, the first selection interface comprises a switch with three different positions:
A first position associated with turning the device off
A second position associated with the automatic operating mode of the device
A third position associated with the manual operating mode of the device.
   The first selection interface is thus designed to force the user to select either automatic or manual mode, as soon as the device is turned on, and thus prohibit any unfortunate combination between manual and automatic operating modes. This improves the simplicity, intuitiveness and ergonomics of the device.

According to one embodiment, the activation of said at least one massage element results in a movement thereof, so as to transmit a mechanical effort to the area to be massaged, preferentially the skin of the face. More specifically, the actuator is designed to activate said at least one massage element according to a rotational movement around a first axis, said first mode and second mode each being associated with a different direction of rotation of said at least one massage element. In other words, the direction of rotation of the massage element(s) may vary, advantageously by varying the direction of rotation of the actuator. Preferentially, the actuator comprises an electric motor that is therefore designed to activate said at least one massage element according to a rotational movement around the first axis. Advantageously, the actuator is powered by a battery. For example, the first operating mode corresponds to a rotation in the anticlockwise direction of the motor (and therefore advantageously said at least one massage element), while the second operating mode corresponds to a rotation in the clockwise direction of the motor (and therefore advantageously said at least one massage element). This embodiment is particularly well-suited to reproducing the kneading or shearing gesture.

Preferentially, the massage device is a facial massage device and said setting is representative of the left or right side of the user's face that the user wishes to treat first, said setting thus being able to have a first value representative of a priority treatment on the left side of the user's face, or, a second value representative of a priority treatment on the right side of the user's face. Indeed, most users are used to always starting a facial (makeup, massage, etc.) on the same side: either the right or the left. It is thus possible, with the invention, to propose a device capable of taking into account and adhering to this user habit. For example, with the invention, the risk that the user will place the device on the wrong side of the face is limited since he or she will be able to proceed with their usual routine. This is all the more important and useful, as the direction of certain massage gestures (and in particular kneading or shearing) is associated with only one side of the face. This association should therefore be adhered to. In a massage parlor, the professional masseur adjusts the direction of the gesture to the side of the face that he or she is massaging, but with an automatic device, it is up to the user to perform this task. The invention makes it possible to help him or her in this task. Thus, whatever the user's habits, the result of the massage provided by the device is optimal.

Thus, advantageously, said first mode is associated with the anticlockwise direction of rotation if the setting has the first value, and, said second mode is associated with the clockwise direction if the setting has the second value. This ensures that the correct direction of rotation of said at least one massage element is applied to the correct side of the user's face. Indeed, in order for the result to be conclusive, and in particular in order to reduce facial sagging and slackening (due to aging cells and gravity), particularly in the case of the kneading or shearing gesture, it is preferable that the skin of the face is moved upwards and outwards (from the chin towards the cheeks and towards the temples). This allows the skin to be tightened in a direction opposite the direction of natural sagging. The invention makes it possible to guarantee this correct skin movement, in this case a right rotation (clockwise) for the right side of the face and a left rotation (anticlockwise) for the left side of the face, regardless of the setting selected by the user. Thus, the invention makes it possible to systematically guarantee that the skin is moved in the chin-nose-temple direction when the device is placed on the cheek.

According to one embodiment, which can be combined with the previous one, the device comprises a first timer designed to be triggered by the controller when the user selects the automatic operating mode of the device. In other words, the device will measure how long the device remains waiting for the setting to be selected. Preferentially, the controller is designed to turn the device off when the first timer exceeds a first threshold time without the user having to select that setting. In other words, the device is designed to turn off automatically after a predefined time, after the user has activated the automatic mode with the first selection interface, but before the user has selected the setting using the second selection interface. Thus, if the user takes too long to select said setting (that is, to manipulate the second selection interface), or if he or she forgets to do so, the device can automatically turn off after a certain period of time, thus avoiding any unnecessary consumption of power from the device, and, when the device is powered by a battery, preserving the battery life of the device.

According to one embodiment, which can be combined with one of the previous ones, the device comprises a first mode timer and a second mode timer designed to be respectively triggered by the controller when selecting the first mode or the second mode. This enables the device to precisely control the activation time of each of said first mode and second mode. Preferentially, the controller is designed to turn off the first mode when the first mode timer exceeds a first mode threshold time and to turn off the second mode when the second mode timer exceeds a second mode threshold time.

According to one embodiment, which can be combined with one of the previous ones, the device comprises an indicator, preferentially visual, representative of the setting to be selected or selected by the user. This gives the user a clear indication that he or she must select that setting or that he or she has selected that setting. Preferentially, said second selection interface comprises said indicator. This makes the operation of the device particularly ergonomic and intuitive since the visual indicator is directly contained in the setting selection interface, which must be operated by the user.

The invention also relates to a preferentially non-therapeutic massage method, comprising the following steps:
a) providing a massage device
b) user selection of an automatic mode of the device offering a cycle for massaging the user
d) user selection of a setting related to the automatic operating mode of the device
e) automatic selection of a first operating mode or a second operating mode of the automatic operation of the device, based on said user-selected setting, said first mode and second mode each being associated with a particular operation of an actuator enabling the activation, advantageously according to a rotational movement around a first axis, of at least one massage element intended to come into contact with the area to be massaged, said first mode and second mode being advantageously associated each with a different direction of rotation of said at least one massage element.

Preferentially, said step of selecting an automatic mode b) comprises a step of activating an indicator, preferably visual, representative of the setting to be selected. Advantageously, the activation of the visual indicator consists of turning on the visual indicator, either continuously, temporarily, alternating (flashing), etc.

Preferentially, said method further comprises, following the step of selecting an automatic mode b), the following time verification step: c) triggering a first timer and, when the value of said first timer exceeds a first threshold time without the user having selected said setting, turning off the device.

Preferentially, the automatic selection step e) comprises, for each of the first mode or second mode, triggering, respectively, a first mode timer or a second mode timer when selecting said mode, and maintaining said first mode or second mode as long as the first mode timer or the second mode timer does not exceed, respectively, a first mode threshold time or a second mode threshold time.

### SHORT DESCRIPTION OF THE DRAWINGS

FIG. 1 illustrates, according to a perspective view, a massage device according to the invention.

FIG. 2 illustrates, in flowchart form, an automatic operating mode of the massage device in FIG. 1.

FIG. 3 illustrates, in flowchart form, a programming variant of the automatic operating mode in FIG. 2, the result for the user being similar to that in FIG. 2.

FIG. 4 illustrates, in flowchart form, a manual operating mode of the massage device in FIG. 1.

FIG. 5 schematically represents a massage method according to the invention.

### DESCRIPTION OF THE EMBODIMENTS

The embodiment of the invention illustrated by the various figures is an embodiment in which the massage device is a human facial massage device, particularly suited to reproducing a kneading or shearing gesture, in particular on the cheeks, cheekbones or neck. The area to be massaged is thus the face, for example the cheeks and cheekbones.

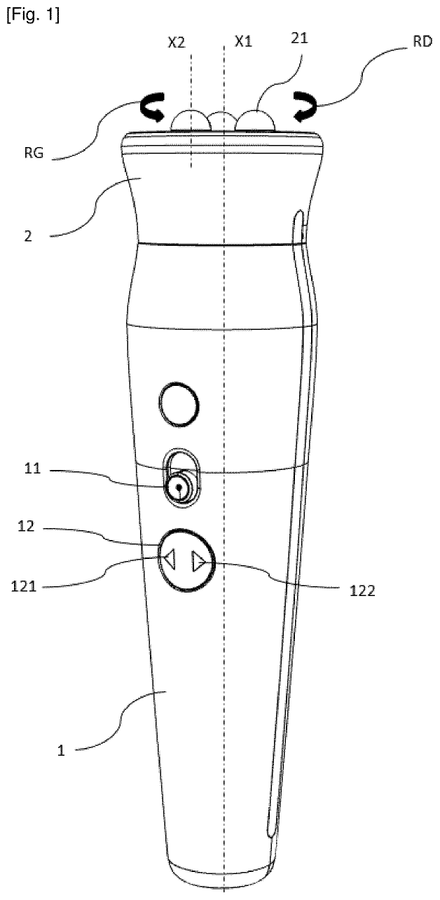

As can be seen in FIG. 1, the massage device comprises a main body 1 and a massage head 2. The massage head 2 is preferentially removable, meaning that it is removably mounted on the main body 1. This allows the user to be able to change the massage head 2, and to replace it at will with another massage head, with different characteristics and therefore suitable for massaging another area. In other words, the massage device may comprise a plurality of different massage heads 2, each having features suited to massaging different areas, for example different areas of the face (neck, forehead, cheeks, eyes, etc.).

The main body 1 thus forms a gripping area, such as a handle, for example. As can be seen, the main body 1 is a solid revolving around a first axis X1, preferentially frustoconical, these shapes being particularly ergonomic and well-suited to a user's grasp.

The massage head 2 comprises at least one massage element 21 intended to come into contact with the area to be massaged. Thus, said at least one massage element 21 protrudes from the massage head 2 so as to be able to come into contact with, and even sink into, the area to be massaged. As can be seen in FIG. 1, the massage head comprises a plurality of massage elements 21, and more specifically three massage elements 21, arranged so as to form the vertices of an equilateral triangle around the first axis X1. The massage elements 21 are movable in rotation around the first axis X1.

The massage device further comprises an actuator enabling activation of said at least one massage element 21, the actuator being preferentially housed in the main body 1. The actuator is thus designed to activate said at least one massage element 21 according to a rotational movement around the first axis X1. Advantageously, the actuator comprises an electric motor designed to activate said at least one massage element 21 according to a rotational movement around the first axis X1. Preferentially, the actuator is powered by a battery, itself housed in the main body 1. Thus, the massage device is a portable and self-contained device, making it easier to use. More specifically, the actuator also comprises a motor shaft connected to the motor.

Said at least one massage element 21 is designed to massage a particular area: its features of size, shape, material, etc. are adapted to the area to be massaged. In the event that the device comprises several removable massage heads 2, each of the massage heads 2 comprises different massage elements 21 intended for different massage areas. Illustratively and without limitation, said at least one massage element 21 comprises a ball, a half sphere, a roller, a finger, etc.

Preferentially, each massage element 21 comprises a convex portion intended to come into contact with the area to be massaged, in this case the face. This feature ensures an effective massage without being unpleasant or painful. For example, each massage element 21 comprises a ball, or a half-ball (or half-sphere), which allows each massage element 21 to sink into the skin of the area to be massaged in order to be able to transmit mechanical forces thereto.

Preferentially, each massage element 21 is mounted movable in rotation on itself, according to a second axis X2 parallel to the first axis X1. The second X2 axis is separate from the first X1 axis. In the preferential embodiment illustrated in FIG. 1, the rotation of each massage element 21 around the second axis X2 is a rotation imposed, in particular by the actuator, that is, by the electric motor. Thus, in the advantageous embodiment illustrated, each massage element 21 has a planetary movement around the first axis X1. The movement of each of the massage devices 21 is therefore linked. In this case, the massage device comprises a transmission device, for example an epicyclic gear train, arranged between the actuator and each massage element 21. The input of the transmission device is thus connected to the motor shaft while the output is connected to each of the massage elements 21. Such a design makes it possible to reproduce the kneading or shearing gesture. Thus, the massage head 2 illustrated in FIG. 1 can be considered as a head for kneading the skin.

As can be seen in FIG. 1, the massage device comprises a first selection interface 11, such as a button or switch. This first selection interface 11 allows the user to select an automatic or manual operating mode of the device. The automatic operating mode provides a treatment cycle for the area to be massaged, preferably the face, and refers to an operating mode of the device in which the user does not have to worry about the massage method to be used, said method being recorded in the massage device. In this automatic operating mode, the user simply places the device on the massage area (on his or her face) and follows the instructions of the massage device. For example, as will be detailed hereafter, the device can automatically time the time associated with each gesture and/or area to be massaged, and then prompt the user to switch areas after a certain time. Conversely, manual operating mode refers to an operating mode of the device in which the user is fully responsible for and free to select the massage method to be used.

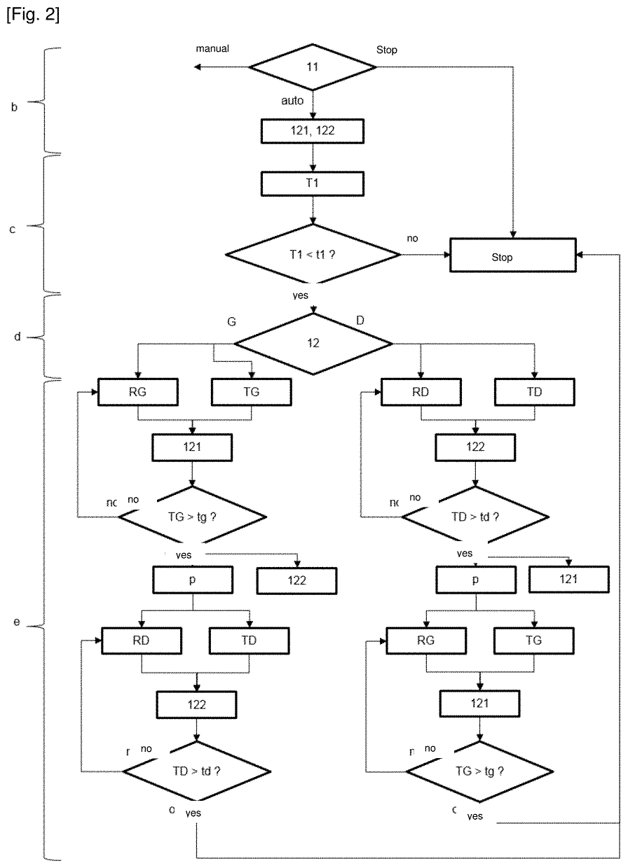

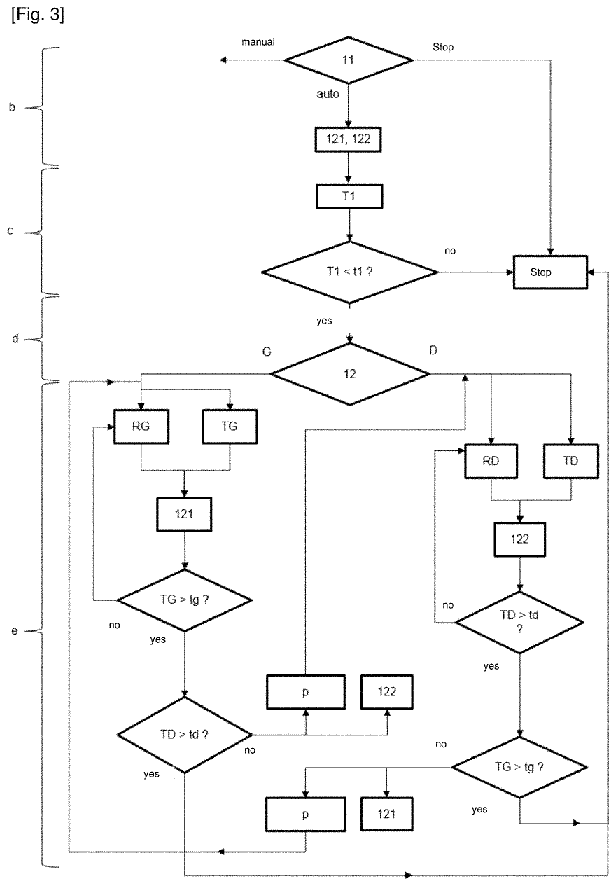

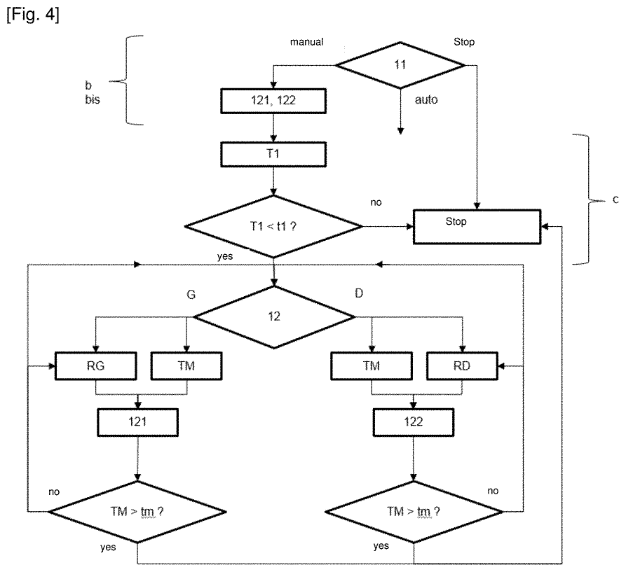

As can be seen in FIGS. 2 to 4, the first selection interface 11 allows the user to set the operation of the massage device to an automatic operating mode (FIG. 2 or 3) or to a manual operating mode (FIG. 4). This is one of the first steps in the massage method that will be described hereafter.

More specifically, the first selection interface 11 comprises a switch with three different positions. The switch is thus a “slider” switch, that is, movable in translation, according to the first axis X1, between three different stable positions:
A first position is associated with turning the device off: this is the center position of the switch, depending on the orientation of FIG. 1.
A second position is associated with the automatic operating mode of the device: this is the top position of the switch, depending on the orientation of FIG. 1.
A third position is associated with the manual operating mode of the device: this is the bottom position of the switch, which is occupied by the switch in FIG. 1.
   Thus, the first selection interface 11 allows the user to select an operation of the device either in an automatic mode or in a manual mode.

As can be seen in FIG. 1, the massage device comprises a second selection interface 12, advantageously different from the first selection interface 11, allowing the user to select a setting G, D. The second selection interface 12 preferentially comprises two push button switches advantageously concealed under a main push button. Said push button switches are arranged in such a way that, when the user exerts pressure on the left portion of the main push button, only the left-handed push switch is activated; whereas when the user exerts pressure on the right portion of the main push button, only the right-handed push switch is activated, according to the orientation in FIG. 1.

Setting G, D is thus related to the automatic operating mode of the device. More specifically, the setting G, D is an input for the automatic operation mode of the device, as can be seen in FIG. 2 or 3. User selection of setting G, D is one of the key steps in the massage method that will be described hereafter. In other words, the automatic operating mode of the device will be different depending on the value the user gives to setting G, D, as can be seen in FIG. 2 or 3 and as detailed hereafter.

In addition, setting G, D is representative of a massage setting. More specifically, said setting G, D is representative of the left or right side of the face to be massaged that the user wishes to treat first. This allows for consideration of the user's habits and routine, taking into account which side of the face the user is used to treating first.

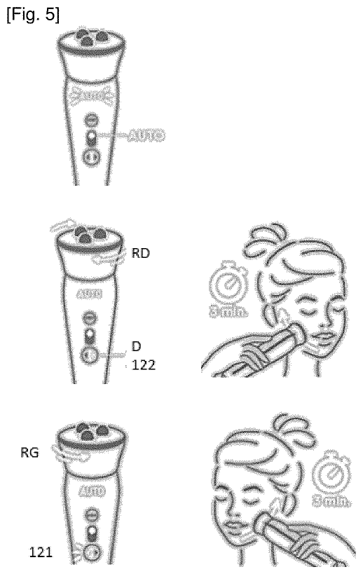

Said setting G, D can thus have a first value G representative of a priority treatment on the left side of the face: in other words, the first value G of the setting tells the massage machine that the left side of the face should be massaged first, and therefore, that the right side of the face should be massaged next. Alternatively, the first setting G, D can also have a second D value representative of a priority treatment on the right side of the face: in other words, the second D value of the setting tells the massage machine that the right side of the face should be massaged first, and therefore, that the left side of the face should be massaged next. This latter configuration (the setting has the D value) is shown in FIG. 5.

The device further comprises a controller automatically selecting a first mode RG or a second mode RD of operation of the automatic operation of the device. Indeed, as can be seen in FIG. 2 or FIG. 3, the automatic operating mode of the device comprises two different variants illustrated by the left and right branches of said figures. The selection of the first mode RG or of the second mode RD of operation is then made according to said setting G, D selected by the user, as illustrated in step d of FIG. 2 or 3. By automatically selecting the first mode RG or the second mode RD of operation, the controller will thus automatically adjust the automatic operating mode of the invention to the value that the user has given to setting G, D, meaning to the preferential habit that the user has indicated. This ensures an optimal massage result, through the automatic mode, while adhering to the preferred habits of the user. Advantageously, the controller comprises, for example in an internal memory, said setting G, D as well as said first value G representative of a priority treatment on the left side of the face and said second value D representative of a priority treatment on the right side of the face.

Said first mode RG and second mode RD are thus each associated with a particular operation of the actuator, and more particularly with a different direction of rotation of the massage element(s) 21. Specifically, the controller will automatically adjust the direction of rotation of the electric motor based on the value the user has given to setting G, D.

According to the embodiment shown in FIG. 2 or 3, said first mode RG is associated with the anticlockwise direction of rotation if the setting has the first value G. Thus, if the setting G, D has its first value G, then the controller will automatically rotate the motor in the anticlockwise direction, that is, counterclockwise, so that the massage elements 21 themselves have a anticlockwise rotational movement around the first axis X1. Said second mode RD is then associated with the clockwise direction of rotation if the setting has the second value D. In other words, if the setting G, D has its second value D, then the controller will automatically rotate the motor clockwise, so that the massage elements 21 themselves have a clockwise rotational movement around the first axis X1. Proper adherence to this association guaranteed by the controller is all the more important in the embodiment illustrated in FIG. 1, where the device comprises three massage elements 21 driven by a planetary movement enabling the kneading or shearing action to be reproduced. In this case, the direction of rotation controlled by the invention involves both the rotation around the first axis X1 but also the rotation of each of the massage elements around their respective second axes X2. Indeed, the purpose of such a massage gesture is in particular to lift the muscle fibers in order to counteract the natural sagging of the face. To do this, it is essential that the skin is manipulated in the opposite direction from the natural sagging direction, that is, the skin must be manipulated from the bottom of the face up (from the chin to the nose) and from the center of the face outward (from the nose to the ears or temples). This is only possible if the massage elements 21 are rotated in the correct direction: on the right side of the face, the rotation must be to the right (clockwise) to ensure the chin-nose-ear movement, while on the left side of the face, the rotation must be to the left (anticlockwise direction) to ensure the same movement. In addition, such movement and direction of rotation significantly reduce the risk of accidental pinching of the skin and make it much easier for the user to move the main body 1. More precisely, the rotational movement automatically adapted to the side of the face being treated will facilitate the macroscopic movement of the main body 1 up the face, always starting from the chin and moving up towards the nose. This macroscopic movement of the main body, provided by the user and combined with the movement of the massage head 2 previously described, also contributes to counteracting facial sagging and thus to the successful result of the massage. The invention guarantees proper adherence to this protocol, as can be seen in FIG. 5, where the user has selected the second value of setting D (he or she wishes to start by treating the right side of the face).

The device also comprises a memory designed to store a number of data, defined by the designers of the device. Preferentially, the memory is a read-only memory so that the various data stored on the memory are not affected by a power outage. A wide variety of data can be stored in the device's memory, such as timings, rotational speeds, rotational directions, setting values, massage methods, etc.

In particular, the memory comprises a first threshold time t1, the value of which is, for example, comprised between 2 and 20 minutes, preferentially between 5 and 15 minutes, advantageously between 10 and 14 minutes. Particularly advantageously, the first threshold time t1 is substantially equal to 12 minutes. As will be explained, this first threshold time t1 is associated with the maximum allowable time for the user to select the setting.

The memory also comprises a first mode threshold time tg, the value of which is, for example, comprised between 30 seconds and 5 minutes, preferentially between 1 and 4 minutes. Advantageously, the first mode threshold time tg is substantially equal to 3 minutes. Thus, the value of the first mode threshold time tg is lower than the value of the first threshold time t1. As will be explained, the first mode threshold time tg is associated with the duration of the first mode RG in the case of automatic operation mode.

The memory also comprises a second mode threshold time td, whose value is for example comprised between 30 seconds and 5 minutes, preferentially between 1 and 4 minutes. Advantageously, the second mode threshold time td is substantially equal to 3 minutes. Thus, the value of the second mode threshold time td is equal to the value of the first mode threshold time tg. As will be explained, the second mode threshold time td is associated with the duration of the second mode RD in the automatic operating mode. The application of the first and second mode threshold times tg, td can be seen in particular in FIG. 5.

The memory also comprises a manual mode threshold time tm, the value of which is for example comprised between 1 and 15 minutes, preferentially between 4 and 8 minutes. Advantageously, the manual mode threshold time tm is substantially equal to 6 minutes. Thus, the value of the manual mode threshold time tm is greater than the value of the first mode threshold time tg but less than the value of the first threshold time t1. As will be explained, the manual mode threshold time tm is associated with the maximum time allowed for the first mode RG or the second mode RD in the case of manual operating mode.

The memory may also comprise a pause time p whose value is for example comprised between 0.5 seconds and 30 seconds, preferentially between 0.5 and 5 seconds, advantageously between 0.5 and 2 seconds. Advantageously, the pause time p is substantially equal to 1 second. Thus, the value of the pause time is an order of magnitude smaller than the threshold times t1, tg, td. As will be explained, the pause time p is used to indicate to the user that it is time to switch the device to the other side of the face.

As can be seen in FIG. 1, the device comprises an indicator, preferentially visual, 121, 122 representative of setting G, D to be selected or selected by the user. More specifically, said second selection interface 12 comprises said visual indicator 121, 122, for example by integrating one or more lighted push buttons.

The indicator 121, 122, thus comprises a first visual indicator 121, preferentially in the form of a left-facing arrow, as well as a second visual indicator 122, preferentially in the form of a right-facing arrow, as can be seen in FIG. 1. The first visual indicator 121 is then representative of the first value G of the setting while the second visual indicator 122 is representative of the second value D of the setting. In addition, the first visual indicator 121 is representative of the first operating mode RG of the device. Lastly, the first visual indicator 121 is representative of the left side of the face to be treated. Conversely, the second visual indicator 122 is representative of the second operating mode and the right side of the face to be treated. This makes it clear to the user which side of the face they should place the massage device on.

The controller is then designed to turn on only the first indicator 121 when the setting has its first value G, and turn on only the second indicator 122 when the setting has its second value D, as can be seen in FIGS. 2 through 5. Preferentially, the controller is designed to activate the first visual indicator 121 or the second visual indicator 122, following or simultaneously with the activation of the first operating mode RG or the second operating mode RD, as illustrated in FIGS. 2 and 3. This makes it very easy and quick for the user to view which setting G, D they selected.

The controller can also be designed to simultaneously activate, or even simultaneously flash, the first and second indicators 121, 122, as soon as the first control interface 11 leaves its first position. This makes it possible to indicate clearly and quickly to the user that he or she must select a value of the setting G, D.

As can be seen in FIGS. 2 through 4, the device comprises a first timer T1 designed to be triggered by the controller when the user selects the automatic operating mode of the device. A timer is any electronic or mechanical component that can count time. Thus, the controller will automatically trigger the first timer T1 as soon as the device is turned on, that is, as soon as the user manipulates the first selection interface 11 and causes it to leave its first position.

As illustrated in FIGS. 2 to 4, the controller is designed to turn off the device when the first timer T1 exceeds the first threshold time t1 without the user having selected said setting G, D. In other words, the controller is designed to monitor, as soon as the device is turned on, that is, as soon as the first selection interface 11 is moved, the time after which the user will activate the second selection interface 12 to give the first value G or second value D to the setting. If the elapsed time is less than the first threshold time t1, the controller keeps the device in the current state, that is, waiting for the user to select the setting G, D. Conversely, if the elapsed time is greater than the first threshold time t1, the controller will automatically turn off the device. This allows the device to automatically shut down at a certain time if the user forgets to select the setting, thus providing significant energy savings and battery life if the device is powered by a battery.

As can be seen in FIG. 2 or 3 and FIG. 4, the controller triggers the first timer T1 regardless of the operating mode (automatic or manual) selected by the user, that is, regardless of the position (second or third) of the first selection interface 11. Energy savings are therefore possible in both the automatic and manual operating modes.

The controller design foreseen for the automatic operation of the device is shown in FIGS. 2 and 3 and is detailed hereafter.

The device comprises a first mode timer TG designed to be triggered by the controller upon selection of the first operating mode RG. The controller is preferentially designed to turn off the first mode RG when the first mode TG timer exceeds the first mode threshold time tg. More specifically, as can be seen in the left branch of the flow charts in FIGS. 2 and 3, the controller is designed to check whether the instantaneous value of the first mode timer TG is greater than the first mode threshold time tg. If the result of this check is negative, the controller will then keep the device in its current operating mode, that is, in the first operating mode RG. The controller is also designed to activate the first visual indicator 121 as long as the first mode RG is active.

The device comprises a second mode timer TD designed to be triggered by the controller upon selection of the second operating mode RD. The controller is preferentially designed to turn off the second mode RD when the second mode TD timer exceeds the second mode threshold time td. More specifically, as can be seen in the right branch of the flow charts in FIGS. 2 and 3 and in FIG. 5, the controller is designed to check whether the instantaneous value of the second mode timer TD is greater than the second mode threshold time td. If the result of this check is negative, the controller will then keep the device in its current operating mode, that is, in the second operating mode RD. The controller is also designed to activate the second visual indicator 122 as long as the second mode RD is active.

The controller is also designed to be able to automatically trigger the second operating mode RD following the first mode RG, or vice versa, automatically trigger the first operating mode RG following the second operating mode RD, depending on the setting G, D selected by the user, as can be seen in FIGS. 2, 3 and 5 (where the user has selected the second value of the setting D). Two design variants can thus be considered for the controller.

A first variant is shown in FIG. 2. In this first variant, the controller is designed to minimize the number of logical tests.

If the result of the verification described in paragraph [0070] is positive (TG>tg), then the controller is designed to pause the actuator during the pause time p. The actuator, and thus said at least one massage element 21 therefore ceases all movement. Such a pause indicates to the user the end of the first operating mode RG and that the device should be moved to the right side of the face. The controller is further designed to also activate the second visual indicator 122 during the pause step which confirms to the user the need to move the device to the right side of the face. At the end of this pause time p, the controller is designed to trigger the second operating mode RD and maintain this second operating mode RD as long as the second operating mode threshold time td is not exceeded by the second operating mode timer TD, as described in paragraph [0071]. As soon as the second mode threshold time td is exceeded by the second mode timer TD, the controller is designed to turn off the massage device.

If the result of the check described in paragraph [0071] is positive (TD>td), then the controller is designed to pause the actuator during the pause time p. The actuator, and thus said at least one massage element therefore ceases all movement. Such a pause indicates to the user the end of the second operating mode RD and that the device should be moved to the left side of the face. The controller is further designed to also activate the first visual indicator 121 during the pause step which confirms to the user the need to move the device to the left side of the face. At the end of this pause time p, the controller is designed to trigger the first operating mode RG and maintain this first operating mode RG as long as the first operating mode threshold time tg is not exceeded by the first operating mode timer TG, as described in paragraph [0070]. As soon as the first mode threshold time tg is exceeded by the first mode timer TG, the controller is designed to turn off the massage device. FIG. 5 schematically shows the result, for the user, of the controller design according to paragraphs [0071] and [0075].

A second variant is shown in FIG. 3. In this second variant, the controller is specifically designed to minimize the number of different steps, but in return, the number of logic tests may be greater.

This second design alternative of the controller differs from the first one in the action to be taken at the end of the first operating mode RG described in paragraph

(conversely, of the second operating mode RD described in paragraph [0071]), that is, when the first mode threshold time tg is exceeded by the first mode timer TG (or conversely, the second mode threshold time td is exceeded by the second mode timer TD). The controller is then designed to check if the second mode threshold time td is exceeded by the second mode timer TD (or conversely, if the first mode threshold time tg is exceeded by the first mode timer TG). If so, then this means that both operating modes RG, RD have already been implemented and the controller is then designed to turn off the device. If not, then this means that only one of the operating modes RG, RD has been implemented and the controller is then designed to activate the other operating mode RG, RD as described in paragraphs [0071] or [0070], after having activated the pause time p and activated the appropriate visual indicator 121, 122.

The controller design foreseen for the manual operation of the device is shown in FIG. 4 and is detailed hereafter.

In the manual operating mode of the device, the controller is designed to give the user the greatest possible freedom. Thus, if the user chooses the first value G (conversely, the second value D), the controller is designed to activate the first operating mode RG (conversely, the second operating mode RD) and simultaneously trigger a manual mode timer TM. The controller is designed to keep this first operating mode RG (conversely, second operating mode RD) active as long as the manual mode threshold time tm is not exceeded by the manual mode timer TM, or as long as the user has not changed the value of the setting G, D using the second selection interface 12. As soon as the manual mode threshold time tm is exceeded by the manual mode timer TM, it means that the user has “forgotten” and the controller is then designed to turn off the device.

A massage method recorded in the device memory and used by the controller will now be described in detail, with reference to FIGS. 2 to 5.

The massage method comprises a first step a) of providing the user with a massage device, preferentially for the face, and advantageously of a device as described above.

The massage method then comprises a second step b) of user selection of an automatic mode of the device providing a massage cycle, preferentially for the face, in particular using the first selection interface 11 described above. Preferentially, as explained above, this also makes it possible to turn on the device.

Preferentially, this second selection step b) further comprises the activation of the indicator 121, 122; in this case, the simultaneous activation of the first and second visual indicators 121, 122, for example in the form of flashing. This will let the user know that he or she has an action to take.

The massage method thus comprises a third step c) of time verification comprising the following steps:
triggering the first timer T1 following step b)
checking if the value of the first timer T1 is lower than the value of the first threshold timer t1,
if not, turning off the device, as this means the user “forgot”
if so, waiting for user selection using the second control interface 12.
   In other words, when the value of said first timer T1 exceeds the first threshold time t1 without the user having selected said setting G, D, turning off the device.

The massage method thus comprises a fourth step d) of user selection of the setting G, D related to the automatic operating mode of the device, in particular using the second control interface 12. The indicator 121, 122 is thus representative of the setting G, D to be selected.

The massage method thus comprises a fifth step e) of automatically selecting the first RG or the second RD operating mode of the automatic operation of the device, depending on said setting G, D selected by the user. The said first mode RG and second mode RD then being each associated with a particular operation of the actuator allowing the activation, advantageously according to a rotational movement around a first axis (X1), of at least one massage element 21 intended to come into contact with the area to be massaged, preferentially the skin of the face. Said first RG and second RD operating mode are then advantageously each associated with a different direction of rotation of said at least one massage element 21. As explained, this step allows the user's preferences to be taken into account while ensuring optimal massage results.

Preferentially, the automatic selection step (e) comprises, for each of the first mode RG or second mode RD, triggering, respectively, a first mode timer TG or a second mode timer TD upon selection of said mode, and maintaining said first mode RG or second mode RD as long as the first mode timer TG or the second mode timer TD does not exceed, respectively, a first mode threshold time tg or a second mode threshold time td.

More specifically, if the setting G is selected by the user using the second control interface 12, then step e) comprises the following successive steps:
Activating the first operating mode RG (anticlockwise rotation to treat the left side of the face) and simultaneously,
Triggering the first mode timer TG;
Activating the first visual indicator 121, in order to inform the user that he or she must apply the device on the left side of the face;
Checking if the value of the first mode timer TG is greater than the first mode threshold time tg;
If not, maintaining the first operating mode RG, as this means that the time provided for the treatment of the left side of the face has not yet elapsed;

FIG. 2 thus illustrates a first variant of step e), following the check of paragraph [0088]:
If so, applying the pause time p during which the operation of the actuator is suspended, in order to inform the user that he or she must switch the device to the other side; and simultaneously activating the second visual indicator 122,
Activating the second operating mode RD (clockwise rotation to treat the right side of the face) and simultaneously,
Triggering the second mode timer TD;
Activating the second visual indicator 122, in order to inform the user that he or she must apply the device on the right side of the face;
Checking if the value of the second mode timer TD is greater than the second mode threshold time td;
If not, maintaining the second operating mode RD, as this means that the time provided for the treatment of the right side of the face has not yet elapsed;
If so, turning off the device.

FIG. 3 thus illustrates a second variant of step e) following the check of paragraph [0088]
If so, checking if the value of the second mode timer TD is greater than the second mode threshold time td;
If so, turning off the device because this means that both operating modes have been applied;
If not, applying the pause time p during which the operation of the actuator is suspended, in order to inform the user that he or she must switch the device to the other side; and simultaneously activating the second visual indicator 122,
Activating the second operating mode RD as described in paragraphs [0091] and [0093].

Conversely, if the setting D is selected by the user using the second control interface 12 (as is the case in FIG. 5), then step e) comprises the following steps:
Activating the second operating mode RD (clockwise rotation to treat the right side of the face) and simultaneously,
Triggering the second mode timer TD;
Activating the second visual indicator 122, in order to inform the user that he or she must apply the device on the right side of the face;
Checking if the value of the second mode timer TD is greater than the second mode threshold time td;
If not, maintaining the second operating mode RD, as this means that the time provided for the treatment of the right side of the face has not yet elapsed;

FIG. 2 thus illustrates a first variant of step e), following the check of paragraph [0091]:
If so, applying the pause time p during which the operation of the actuator is suspended, in order to inform the user that he or she must switch the device to the other side; and simultaneously activating the second visual indicator 121,
Activating the first operating mode RG (anticlockwise rotation to treat the left side of the face) and simultaneously;
Triggering the first mode timer TG;
Activating the first visual indicator 121, in order to inform the user that he or she must apply the device on the left side of the face, as can be seen in FIG. 5;
Checking if the value of the first mode timer TG is greater than the first mode threshold time tg;
If not, maintaining the first operating mode RG, as this means that the time provided for the treatment of the left side of the face has not yet elapsed;
If so, turning off the device.

FIG. 3 thus illustrates a second variant of step e) following the check of paragraph [0091]
If so, checking if the value of the first mode timer TG is greater than the first mode threshold time tg;
If so, turning off the device because this means that both operating modes have been applied;
If not, applying the pause time p during which the operation of the actuator is suspended, in order to inform the user that he or she must switch the device to the other side; and simultaneously activating the second visual indicator 121,
Activating the first operating mode RG as described in paragraphs [0088] and

In a manual variation of the massage method, illustrated in FIG. 4, the latter may comprise, following the first step a), a second step b) bis of user selection of a manual mode of the device, in particular using the first selection interface 11 described above. Preferentially, as explained above, this also makes it possible to turn on the device.

Preferentially, this second selection step b) bis further comprises the activation of the indicator 121, 122; in this case, the simultaneous activation of the first and second visual indicators 121, 122, for example in the form of flashing. This will let the user know that he or she has an action to take.

The manual variation of the massage method thus comprises the verification step c) as described in paragraph [0084].

The manual variation of the massage method thus comprises a step of user selection of setting G, D related to the manual operating mode of the device, in particular using the second control interface 12. The indicator 121, 122 is thus representative of the setting G, D to be selected.

If the setting has the first value G, then the manual variant of the massage method comprises the following successive steps:
Activating the first operating mode RG (anticlockwise rotation to treat the left side of the face), and simultaneously,
Triggering the manual mode timer TM;
Activating the first visual indicator 121, in order to inform the user that he or she must apply the device on the left side of the face;
Checking if the value of the manual mode timer TM is greater than the manual mode threshold time tm;
If not, maintaining the first operating mode RG until the user has changed the value of setting G, D using the second selection interface 12
If so, turning off the device

If the setting has the second D value, then the manual variant of the massage method comprises the following successive steps:
Activating the second operating mode RD (clockwise rotation to treat the right side of the face), and simultaneously,
Triggering the manual mode timer TM;
Activating the second visual indicator 122, in order to inform the user that he or she must apply the device on the right side of the face;
Checking if the value of the manual mode timer TM is greater than the manual mode threshold time tm;
If not, maintaining the second operating mode RD until the user has changed the value of setting G, D using the second selection interface 12
If so, turning off the device.

1. A massage device comprising:
a first selection interface allowing a user to select an automatic or manual operating mode of the device, said automatic operating mode providing a treatment cycle for the area to be massaged,
a second selection interface allowing a user to select a parameter related to the automatic operation mode of the device and representative of a massage setting,
a massage head comprising at least one massage element intended to come into contact with the area to be massaged,
an actuator enabling activation of said at least one massage element according to a rotational movement around a first axis,
characterized in that the device further comprises
a controller automatically selecting a first mode or a second mode of operation of the automatic operation of the device, depending on said user-selected setting, said first mode and second mode each being associated with a particular operation of the actuator, said first operating mode and second operating mode each being associated with a different direction of rotation of said at least one massage element.

2. The massage device according to claim 1, wherein the actuator comprises an electric motor.

3. The massage device according to claim 1, wherein the massage device is a facial massage device, said setting is representative of the left or right side of the face to be massaged that the user wishes to treat first, said setting then being able to have a first value representative of a priority treatment on the left side of the face or a second value representative of a priority treatment on the right side of the face, the controller comprising said setting as well as said first value and said second value.

4. The massage device according to claim 3, wherein said first mode is associated with the anticlockwise direction of rotation if the setting has the first value, and said second mode is associated with the clockwise direction of rotation if the setting has the second value.

5. The massage device according to claim 1, wherein the device comprises a first timer designed to be triggered by the controller when the user selects the automatic operating mode of the device.

6. The massage device according to claim 5, wherein the controller is designed to turn off the device when the first timer exceeds a first threshold time without the user having to select said setting.

7. The massage device according to claim 1, wherein the device comprises a first mode timer and a second mode timer, designed to be triggered by the controller respectively upon selection of the first mode or the second mode.

8. The massage device according to claim 7, wherein the controller is designed to, respectively, turn off the first mode when the first mode timer exceeds a first mode threshold time, and, turn off the second mode when the second mode timer exceeds a second mode threshold time.

9. The massage device according to claim 1, wherein the device comprises an indicator representative of the setting to be selected or selected by the user.

10. The massage device according to claim 9, wherein said second selection interface comprises said indicator.

11. The massage device according to claim 1, wherein the first selection interface comprises a switch with three different positions:
A first position associated with turning the device off
A second position associated with the automatic operating mode of the device
A third position associated with the manual operating mode of the device

12. A non-therapeutic massage method comprising the following steps: a) providing a massage device b) user selection of an automatic mode of the device offering a massage cycle d) user selection of a setting related to the automatic operating mode of the device e) automatic selection of a first operating mode or a second operating mode of the automatic operation of the device, based on said user-selected setting, said first mode and second mode each being associated with a particular operation of an actuator enabling the activation, according to a rotational movement around a first axis, of at least one massage element intended to come into contact with the area to be massaged, said first mode and second mode being associated each with a different direction of rotation of said at least one massage element.

13. The massage method according to claim 12, wherein said step of selecting an automatic mode b) comprises a step of activating an indicator representative of the setting to be selected.

14. The massage method according to claim 13, said method further comprising, following the step of selecting an automatic mode b), the following time verification step: c) triggering a first timer and, when the value of said first timer exceeds a first threshold time without the user having selected said setting, turning off the device.

15. The massage method according to any one of claim 13, wherein the automatic selection step e) comprises, for each of the first mode or second mode, triggering, respectively, a first mode timer or a second mode timer when selecting said mode, and maintaining said first mode or second mode as long as the first mode timer or second mode timer does not exceed, respectively, a first mode threshold time or a second mode threshold time.
